(19) United States
(12) Patent Application Publication
(10) Pub. No.: US 2022/0133458 A1
(43) Pub. Date: May 5, 2022

(54) DENTAL APPARATUS

(71) Applicant: Scott Holyoak, Encinitas, CA (US)

(72) Inventor: Scott Holyoak, Encinitas, CA (US)

(21) Appl. No.: 17/447,401

(22) Filed: Sep. 10, 2021

Related U.S. Application Data
(60) Provisional application No. 63/191,314, filed on May 20, 2021.
(60) Provisional application No. 63/109,335, filed on Nov. 3, 2020.

(51) Int. Cl. A61C 13/15; H05B 47/155

(52) U.S. Cl. CPC A61C 19/004; H05B 47/155

(57) ABSTRACT

A dental apparatus is disclosed that includes an elongated body, a plurality of light-emitting elements distributed along the elongated body, and a controller configured to individually enable the plurality of light-emitting elements.

This application claims priority from application Nos. 63/191,314, filed May 29, 2021, and 63/109,335, filed Nov. 3, 2020, the entire contents of both of which are herewith incorporated by reference.

### TECHNICAL FIELD

This application relates to dentistry tools.

### BACKGROUND

A dentist's primary purpose is to help maintain the health of the body by focusing on the oral cavity. When a person gets dental caries (decay) in a tooth, there are different ways to remove the decay and restore the tooth to optimal strength. The strength is regained through the different materials and types of restoration available. When a tooth has decay, the dentist removes the decay followed by placing a restoration. Some teeth can be restored with a composite resin. The dentist applies an etch material which is rinsed off. Then the dentist applies a bonding agent that must be light-cured. The composite resin is placed in the tooth where the decay was removed and is light-cured.

### SUMMARY

A dental apparatus is disclosed that includes an elongated body, a plurality of light-emitting elements distributed along the elongated body, and a controller configured to individually enable the plurality of light-emitting elements.

### BRIEF DESCRIPTION OF DRAWINGS

FIG. 1 illustrates a dental apparatus.

### DETAILED DESCRIPTION

Most dental bonding agents require between 10-20 seconds to cure and most dental composite resins requires between 20-40 seconds to cure, it takes a lot of time to restore multiple teeth in a dental visit since only one tooth is cured at a time with known dental tools.

In contrast, the dental apparatus disclosed herein comprises multiple light-emitting elements along its handle and can cure restorations associated with five or more teeth simultaneously. Furthermore, crowns that require light-curing cements can be cured simultaneously with the disclosed dental apparatus. The disclosed dental apparatus is also useful to orthodontists who place orthodontic brackets on teeth and cure them using light. Instead of curing one bracket at a time on each of 28 teeth (which typically takes more than 18 minutes), using known dental tools, an orthodontist may use the disclosed dental device to cure the brackets. With the disclosed dental device, the orthodontist could cure the brackets in under 4 minutes.

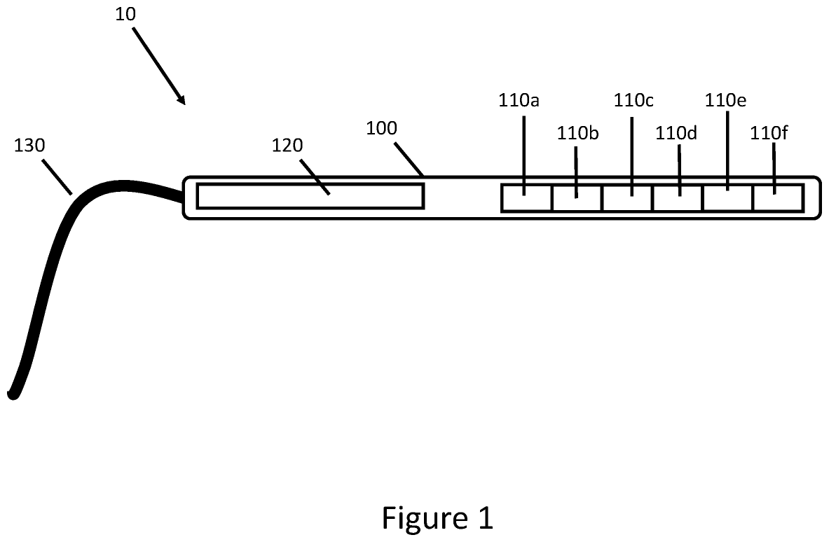

FIG. 1 illustrates a dental apparatus 10 comprising an elongated body 100, a controller 120, a power cord 130, and a plurality of light-emitting elements 110 distributed along elongated body 100. Body 100 may be made of plastic or other material and is sized so that the plurality of light-emitting elements 100 fit within a human mouth. Each light-emitting element emits light when enabled by controller 120. For example, each light-emitting element may emit ultra-violet light. Power cord 130 provides electric power to light-emitting elements 110. Body 100 is designed to prevent water, flesh, or other fluids from coining into contact with electricity provided by power cord 130.

Controller 120 may be used to enable all the light-emitting elements 110 at once. This gives full power to each resin being cured. For example, using controller 120, a user may enable all of the light-emitting elements 110 of the apparatus 10 to full power. This allows the dentist to cure multiple teeth at one time.

Controller 120 may include a user interface configured to allow a user of the dental apparatus 10 to individually increase or decrease the intensity of each light-emitting element 110. For example, using controller 120, a user may push a button that corresponds to the specific light-emitting element (e.g., light-emitting element 110a) to increase the intensity of the light. A user may use controller 120 to also reduce intensity of a specific light-emitting element 110. When a tooth is restored, a curing light causes shrinkage of the composite towards the direction of the curing light. By having multiple light emitting elements 110 curing a single restoration, the composite resin is not pulled unidirectional. This increases the strength of the bond and increases the life expectancy of the restoration and tooth.

Each light-emitting element 110 of the plurality of light-emitting elements is configured to radiate light when enabled by controller 120 and to cease radiating light when disabled by controller 120. Controller 120 is configured to allow a user of apparatus 10 to individually enable each light-emitting element 110 of the plurality to operate at a maximum intensity at which the light-emitting element is capable of radiating. For example, controller 120 may comprise a plurality of buttons, each corresponding to a different one of the light-emitting elements 110. In one embodiment, the user may press a button to enable its corresponding light-emitting element to operate at maximum intensity. In another embodiment, controller 120 is configured to individually enable each light-emitting element 110 of the plurality to operate at a selected intensity that is lower than a maximum intensity at which the light-emitting elements 110 are capable of radiating. For example, the user may press a button and the intensity of the light-emitting element 110 corresponding to the button may increase to a desired intensity based on the length of time the user presses the button. In this manner, controller 120 is configured to allow a user to choose the selected intensity of a light-emitting element 110. Controller 120 may comprise user interface elements other than buttons that control the intensity of the light-emitting elements. For example, controller 120 may comprise a screen, knobs, sliders, or other user interface elements. Controller 120 may operate as a timer that enables one or more light-emitting elements for a predetermined amount of time when enabled by a user. For example, a user may configure controller 120 to enable one or more light-emitting elements for 5 seconds or 10 seconds or 15 seconds or 20 seconds or 30 seconds or 40 seconds or for some other period of time.

In one embodiment, the light-emitting elements 110 are square. In another embodiment, the light-emitting elements 110 are round. In another embodiment, the light-emitting elements are rectangular. In any of these embodiments, light-emitting elements of the plurality that are adjacent to each other may be in physical contact with each other. For example, light-emitting element 110a may be physically touching light-emitting element 110b, and light-emitting element 110b may be physically touching light-emitting element 110c, and light-emitting element 110c may be physically touching light-emitting element 110d, and light-emitting element 110e may be physically touching light-emitting element 110e, and light-emitting element 110e may be physically touching light-emitting element 110f.

Body 100 may be linear and the plurality of light emitting elements may be distributed linearly along the elongated body as illustrated in FIG. 1. In other embodiments, body 100 may be curved, for example, body 100 may have a curvature that matches the buccal curvature of the dental arch of the human mouth. Each light-emitting element 110 of the plurality of light-emitting elements is configured to emit light in a direction perpendicular to the length of elongated body 100. In some embodiments, the curve of body 100 is adjustable. For example, in one embodiment, body 100 comprises one or more joints that enable the curve of body 100 to be adjustable. In one embodiment, body 100 comprises a plurality of joints distributed along body 100 allowing body 100 to be adjusted into a plurality of different shapes. In one embodiment, each joint of the plurality is located between two different light-emitting elements 110 of the device. This allows for each light-emitting element of the plurality to project light directly onto a tooth such that the angle between the direction of the light emitted by the element and the face of the tooth is approximately ninety degrees. The joints allow the professional using the device to adapt the shape of the device to the shape of the mouth in the area of the mouth in which the device is being used. For example, if the device is being used in the front of the mouth, the joints may be configured such that the device forms a curved shape. If the device is being used in the rear of the mouth, the joints may be configured such that the device forms a straight shape. In one embodiment, the joints may be hinges. In another embodiment, the joints may be formed from a flexible material that holds it shape when curved.

In one embodiment, the plurality of light-emitting elements 110 consists of five light-emitting elements 110 and a distance spanned by the plurality of light-emitting elements 110 is approximately equal to a distance spanned by five human adult teeth. In other embodiments, the plurality of light-emitting elements 110 consists of fewer than five light-emitting elements or more than five light-emitting elements. Each light-emitting element 110 of the plurality of light-emitting elements may be spaced apart from the one or two light-emitting elements of the plurality of light-emitting elements nearest the light-emitting element by a distance approximately equal to a distance between the centers of two human adult teeth. For example, the distance between the center of light-emitting element 110b and the center of light-emitting element 110a may be approximately equal to a distance between the centers of two human adult teeth or approximately equal to a distance between the centers of two human child teeth. Similarly, the distance between the center of light-emitting element 110b and the center of light-emitting element 110c may be approximately equal to a distance between the centers of two human adult teeth or approximately equal to a distance between the centers of two human child teeth. In one embodiment of apparatus 10, each light-emitting element 110 of the plurality of light-emitting elements is spaced apart from the one or two light-emitting elements of the plurality of light-emitting elements nearest the light-emitting element by a same distance.

Apparatus 10 may operate a plurality of different modes. Controller 120 may comprise a user interface configured to allow a user to select a mode of operation of apparatus 10 from among a plurality of modes.

In a first mode, controller 120 enables two of the light-emitting elements 110 of the plurality such that the two light-emitting elements emit light at the same time. In this mode, the two light-emitting elements 100 are immediately adjacent to one another. For example, when operating in the first mode, controller 120 may enable light-emitting elements 110a and 110b, or may enable light-emitting elements 110b and 110c, or may enable light-emitting elements 110c and 110d, or may enable light-emitting elements 110d and 110e, or may enable light-emitting elements 110e and 110f. The first mode of operation may be used to simultaneously cure restoration material associated with two dental caries in two adjacent teeth, to simultaneously cure cement associated with two crowns on two adjacent teeth, or to simultaneously cure a bonding agent associated with two orthodontic brackets of two adjacent teeth.

In a second mode, controller 120 enables two of the light-emitting elements 110 of the plurality such that the two light-emitting elements emit light at the same time and at least one light-emitting element 100 of the plurality is located between the two light-emitting elements. For example, when operating in the second mode, controller 120 may enable light-emitting elements 110a and 110c, or may enable light-emitting elements 110a and 110d, or may enable light-emitting elements 110a and 110e, or may enable light-emitting elements 110a and 110f, or may enable light-emitting elements 110b and 110d, or may enable light-emitting elements 110b and 110e, or may enable light-emitting elements 110b and 110f, or may enable light-emitting elements 110c and 110e, or may enable light-emitting elements 110c and 110f, or may enable light-emitting elements 110d and 110f. The second mode of operation may be used to simultaneously cure restoration material associated with two dental caries in two non-adjacent teeth or to simultaneously cure cement associated with two crowns of two non-adjacent teeth or to simultaneously cure a bonding agent associated with two orthodontic brackets of two non-adjacent teeth.

When operating in the second mode, controller 120 is configured to enable the two light-emitting elements 110 to radiate light at a selected intensity that is lower than a maximum intensity at which the two light-emitting elements are capable of radiating. Controller 120 may be configured to allow a user to select the selected intensity, for example using a user interface such as a touch screen, dial, or button. When operating in the second mode, the controller may be configured to enable the two light-emitting elements 100 to radiate light at a maximum intensity at which the two light-emitting elements are capable of radiating.

In a third mode, controller 120 is configured to enable three of the light-emitting elements 110 of the plurality such that the three light-emitting elements emit light at the same time. The three light-emitting elements 110 of the plurality may be adjacent to each other such that no other light-emitting element of the plurality is located between two of the three light-emitting elements. The three light-emitting elements 110 comprise a first light-emitting element of the plurality (e.g., light-emitting element 110d), a second light-emitting element of the plurality (e.g., light-emitting element 110e), and a third light-emitting element of the plurality (e.g., light-emitting element 110f). The second light-emitting element 110e is located between the first light-emitting element 110d and the third light-emitting element 110f. When operating in the third mode, controller 120 is configured to enable the first light-emitting element 110d to radiate light at a first intensity, enable the second light-emitting element 110e to radiate light at a second intensity, and enable the third light-emitting element 110f to radiate light at a third intensity.

The second intensity may be greater than the first intensity and the second intensity may be greater than the third intensity. In one configuration, the first intensity and the third intensity are less than seventy-five percent of the second intensity. In another configuration, the first intensity and the third intensity are less than fifty-five percent of the second intensity. In either of these configurations, the first intensity may be the same as the third intensity. When operating in the third mode, controller 120 may be configured to prevent the light-emitting elements 110 of the plurality other than the first light-emitting element, the second light-emitting element, and the third light-emitting element from radiating light. Doing so may prevent apparatus 10 from creating unnecessary heat in the patient's mouth.

In one configuration of the third mode, the first intensity is a maximum intensity of the first light-emitting element, the second intensity is a maximum intensity of the second light-emitting element, and the third intensity is a maximum intensity of the third light-emitting element. In another configuration of the third mode, the first intensity is the same as the second intensity and the second intensity is the same as the third intensity.

The third mode of operation may be used to cure restoration material associated with one dental cavity in one tooth or to cure cement associated with a crown on one tooth or to cure a bonding agent associated with one orthodontic bracket of one tooth. In this mode, a user may position apparatus 10 so that the second light-emitting element shines on the tooth with the cavity or crown or orthodontic bracket. In this mode, light from the first light-emitting element and light from the third light-emitting element will also radiate onto the tooth with the cavity or crown or orthodontic bracket since these light-emitting elements are adjacent to the second light-emitting element. The additional light from the first and third light-emitting elements helps the restoration material associated with the one dental cavity or the one crown or the bonding agent associated with the one orthodontic bracket cure more quickly and more evenly than if only the second light-emitting element was enabled.

In a fourth mode, controller 120 enables all of the light-emitting elements 110 of the plurality such that all of the light-emitting elements of the plurality emit light at the same time. Controller 120 may be configured to enable all of the light-emitting elements to radiate light at a selected intensity that is lower than a maximum intensity at which the light-emitting elements 110 are capable of radiating. In one embodiment, controller 120 may be configured to allow a user of apparatus 10 to select the selected intensity. In another configuration of the fourth mode, controller 120 may be configured to enable all of the light-emitting elements to radiate light at a maximum intensity at which the light-emitting elements are capable of radiating. The fourth mode of operation may be used to simultaneously cure a bonding agent associated with a plurality of adjacent orthodontic brackets located on a plurality of adjacent teeth. Doing so is advantageous because all of the brackets may be bonded simultaneously which consumes far less time than individually curing the bonding agent of each bracket one at a time.

In a fifth mode, controller 120 enables five of the light-emitting elements 110 of the plurality such that the five light-emitting elements emit light at the same time. The five light-emitting elements of the plurality are adjacent to each other such that no other light-emitting element of the plurality is located between the five light-emitting elements, the five light-emitting elements comprising a first light-emitting element (e.g., light-emitting element 110a), a second light-emitting element (e.g., light-emitting element 110b), a third light-emitting element (e.g., light-emitting element 110c), a fourth light-emitting element (e.g., light-emitting element 110d), and a fifth light-emitting element (e.g., light-emitting element 110e).

The second light-emitting element is located between the first light-emitting element and the third light-emitting element. The fourth light-emitting element is located between the third light-emitting element and the fifth light-emitting element. When operating in the fifth mode, controller 120 is configured to enable the first light-emitting element to radiate light at a first intensity, enable the second light-emitting element to radiate light at a second intensity, enable the third light-emitting element to radiate light at a third intensity, enable the fourth light-emitting element to radiate light at a fourth intensity, and enable the fifth light-emitting element to radiate light at a fifth intensity. The second intensity may be greater than the first intensity and the second intensity may be greater than the third intensity, and the fourth intensity may greater than the third intensity and the fourth intensity may greater than the fifth intensity.

In one configuration of the fifth mode, the first intensity and the third intensity are less than seventy-five percent of the second intensity and the third intensity and the fifth intensity are less than seventy-five percent of the fourth intensity. In another configuration of the fifth mode, the first intensity and the third intensity are less than fifty-five percent of the second intensity and the third intensity and the fifth intensity are less than fifty-five percent of the fourth intensity. In another configuration of the fifth mode, the first intensity is the same as the third intensity and the third intensity is the same as the fifth intensity. When operating in the fifth mode, controller 120 may be configured to prevent the light-emitting elements of the plurality other than the five light-emitting elements from radiating light.

The fifth mode of operation may be used to simultaneously cure restoration material associated with one dental cavity in a first tooth and another dental cavity in a second tooth if the first and second teeth are separated by one other tooth. Alternatively, the fifth mode of operation may be used to simultaneously cure a bonding agent associated with one orthodontic bracket of a first tooth and another orthodontic bracket of a second tooth if the first and second teeth are separated by one other tooth. Alternatively, the fifth mode of operation may be used to simultaneously cure cement associated with one crown of a first tooth and another crown of a second tooth if the first and second teeth are separated by one other tooth. In this mode, a user may position apparatus 10 so that the second light-emitting element shines on the first tooth with the cavity or crown or orthodontic bracket. In this fifth mode, light from the first light-emitting element and light from the third light-emitting element will also radiate onto the tooth with the cavity or crown or orthodontic bracket since these light-emitting elements are adjacent to the second light-emitting element. The additional light from the first and third light-emitting elements helps the restoration material associated with the one dental cavity or the bonding agent associated with the one orthodontic bracket or the cement associated with the crown cure more quickly and more evenly than if only the second light-emitting element was enabled. The fourth light-emitting element shines on the second tooth with the cavity or orthodontic bracket or crown. In this fifth mode, light from the third light-emitting element and light from the fifth light-emitting element will also radiate onto the second tooth with the cavity or orthodontic bracket or crown since these light-emitting elements are adjacent to the fourth light-emitting element. In this fifth mode, light from the third light-emitting element will radiate onto both the first tooth with the cavity or orthodontic bracket or crown and the second tooth with the cavity or orthodontic bracket or crown.

What is claimed is:

1. A dental apparatus comprising:
an elongated body;
a plurality of light-emitting elements distributed along the elongated body; and
a controller configured to individually enable the plurality of light-emitting elements.

2. The dental apparatus of claim 1, wherein each light-emitting element of the plurality of light-emitting elements is configured to radiate light when enabled by the controller and to cease radiating light when disabled by the controller.

3. The dental apparatus of claim 2, wherein the controller is configured to individually enable each light-emitting element of the plurality to operate at a maximum intensity at which the light-emitting element is capable of radiating.

4. The dental apparatus of claim 2, wherein the controller is configured to individually enable each light-emitting element of the plurality to operate at a selected intensity that is lower than a maximum intensity at which the light-emitting element is capable of radiating.

5. The dental apparatus of clam 4 wherein the controller is configured to allow a user to choose the selected intensity.

6. The dental apparatus of claim 1, wherein the elongated body is linear and the plurality of light emitting elements are distributed linearly along the elongated body.

7. The dental apparatus of claim 1, wherein the elongated body is curved.

8. The dental apparatus of claim 1, wherein the plurality of light-emitting elements consists of five light-emitting elements and a distance spanned by the plurality of light-emitting elements is approximately equal to a distance spanned by five human adult teeth.

9. The dental apparatus of claim 1, wherein each light-emitting element of the plurality of light-emitting elements is spaced apart from the one or two light-emitting elements of the plurality of light-emitting elements nearest the light-emitting element by a distance approximately equal to a distance between the centers of two human adult teeth.

10. The dental apparatus of claim 1, wherein the controller comprises a user interface configured to allow a user to select a mode of operation of the dental apparatus from among a plurality of modes.

11. The dental apparatus of claim 10, wherein the controller is configured to operate in a first mode of the plurality of modes in which:
the controller enables two of the light-emitting elements of the plurality such that the two light-emitting elements emit light at the same time; and
the two light-emitting elements are immediately adjacent to one another.

12. The dental apparatus of claim 11, wherein the controller is configured to operate in a second mode of the plurality of modes in which:
the controller enables two of the light-emitting elements of the plurality such that the two light-emitting elements emit light at the same time; and
at least one light-emitting element of the plurality is located between the two light-emitting elements.

13. The dental apparatus of claim 12 wherein when operating in the second mode, the controller is configured to enable the two light-emitting elements to radiate light at a selected intensity that is lower than a maximum intensity at which the two light-emitting elements are capable of radiating.

14. The dental apparatus of clam 13 wherein the controller is configured to allow a user to select the selected intensity.

15. The dental apparatus of claim 12, wherein the controller is configured to operate in a third mode of the plurality of modes in which:
the controller enables three of the light-emitting elements of the plurality such that the three light-emitting elements emit light at the same time; and
the three light-emitting elements of the plurality are adjacent to each other such that no other light-emitting element of the plurality is located between two of the three light-emitting elements.

16. The dental apparatus of claim 15 wherein:
the three light-emitting elements comprise a first light-emitting element of the plurality, a second light-emitting element of the plurality, and a third light-emitting element of the plurality;
the second light-emitting element is located between the first light-emitting element and the third light-emitting element; and
when operating in the third mode, the controller is configured to:
enable the first light-emitting element to radiate light at a first intensity;
enable the second light-emitting element to radiate light at a second intensity; and
enable the third light-emitting element to radiate light at a third intensity.

17. The dental apparatus of claim 16 wherein the second intensity is greater than the first intensity and the second intensity is greater than the third intensity.

18. The dental apparatus of claim 17 wherein the first intensity and the third intensity are less than seventy-five percent of the second intensity.

19. The dental apparatus of claim 12, wherein the controller is configured to operate in a fourth mode of the plurality of modes in which:
the controller enables all of the light-emitting elements of the plurality such that all of the light-emitting elements of the plurality emit light at the same time.

20. The dental apparatus of claim 19 wherein when operating in the fourth mode, the controller is configured to enable all of the light-emitting elements to radiate light at a selected intensity that is lower than a maximum intensity at which the light-emitting elements are capable of radiating.
